(19) United States
(12) Patent Application Publication
(10) Pub. No.: US 2016/0253773 A1
(43) Pub. Date: Sep. 1, 2016

(54) PATH CALCULATION DEVICE, PATH CALCULATION METHOD AND PROGRAM

(71) Applicant: NEC CORPORATION, Minato-ku, Tokyo (JP)

(72) Inventors: Jun SUZUKI, Tokyo (JP); Masaki KAN, Tokyo (JP); Yuki HAYASHI, Tokyo (JP)

(21) Appl. No.: 15/030,738

(22) PCT Filed: Oct. 30, 2014
(86) PCT No.: PCT/JP2014/078880

§ 371 Date: Apr. 20, 2016

(30) Foreign Application Priority Data
Oct. 30, 2013 (JP) 2013-225803

(51) Int. Cl. G06T 1/20; G06F 17/30

(52) U.S. Cl. CPC G06T 1/20; G06F 17/30958

(57) ABSTRACT

Provided is a path calculation device including a calculation unit for performing assigned processing in parallel using a plurality of threads, and a control unit for controlling the calculation unit. The control unit divides nodes that are included in a graph which is object of path calculation, into groups in accordance with distances from a start node. And The control unit causes the calculation unit to perform path calculations between the start node and nodes belonging to a group of nodes to which distances from the start node are relatively short and thereafter to perform path calculations between the start node and nodes belonging to a group of nodes to which distances from the start node are relatively long.

### TECHNICAL FIELD

### Reference to Related Application

The present invention claims priority from Japanese Patent Application 2013-225803 (filed on Oct. 30, 2013) the content of which is hereby incorporated in its entirety by reference into this Description.

The present invention relates to a path calculation device, a path calculation method, and a program, and, more particularly, relates to a path calculation device, a path calculation method, and a program using an accelerator.

### BACKGROUND ART

An example of a path calculation device using an accelerator is disclosed in NPL 1. The accelerator is a device that is capable of performing calculation with a substantially high degree of parallelism in a high-speed manner in calculation performed in a CPU (Central Processing Unit). Offloading such calculation from the CPU to the accelerator enables the calculation to be performed in a high-speed manner. As an example of a device that is used as an accelerator, a GPU (Graphics Processing Unit) is known.

A configuration of a path calculation device of a related technology using an accelerator is illustrated in FIG. 10. With reference to FIG. 10, the path calculation device using an accelerator includes a GPU control CPU 1, which controls a GPU, and a GPU board 6. In the GPU control CPU 1, a GPU control program 13 runs. The GPU control CPU 1 and the GPU board 6 are interconnected by an I/O bus 5.

The GPU board 6 includes a GPU 61 that performs path calculations and a GPU memory 62 that stores graph data 621. In the GPU 61, a path calculation program 611 that performs path calculations runs.

FIG. 11 illustrates graph data 621 that the GPU memory 62 stores. In the following description, it is assumed, as an example, that the graph data 621 are data corresponding to a graph 41 illustrated in FIG. 4. The graph data 621 contain an edge distance array G31 that contains costs of edges connecting respective nodes in the graph to each other. The graph data 621 contain a node distance array G32 that contains distances from a start node to all the nodes in the graph for which path calculations are performed. The graph data 621 contain a node updating distance array G33 that contains updating values of the node distance array. The graph data 621 contain a path array G34 each element of which indicates the last node before each node in the shortest path of the node from a start node. The graph data 621 contain an update array G35 each element of which indicates whether or not a distance has been updated at each node in path calculations. The number of elements in the edge distance array G31 is equal to the number of edges in the graph 41. The number of elements of each of the node distance array G32, the node updating distance array G33, the path array G34, and the update array G35 is equal to the number of nodes in the graph 41.

The GPU 61 includes a plurality of cores 612 that perform calculations. The GPU 61 achieves a speed-up of the path calculations by means of performing calculations in parallel using a plurality of cores 612.

An operation of the path calculation device of the related technology will be described with reference to the drawings. In the following description, it is assumed, as an example, that, in the graph illustrated in FIG. 4, distances and shortest paths starting from a node A are to be obtained for all the nodes (A to I) in the graph. FIG. 12 is a flowchart illustrating an operation of the path calculation device as an example.

First, the GPU control program 13 initializes the distance of the node A, which is the start node, to 0 (zero) and the distances of the other nodes B to I to infinity in the node distance array G32 in the GPU memory 62. The GPU control program 13 sets the element of the update array G35 corresponding to the start node A (step S33).

Next, the GPU control program 13 generates, in the GPU 61, as many threads that perform path calculations for the respective nodes in the graph as the number of graph nodes (step S34).

Each of the generated threads runs in one of the cores 612 in the GPU 61. Each of the generated threads confirms whether or not the element of the update array G35 corresponding to the node in the graph for which the thread is in charge of calculation has been set, and, when the element has been set, refers to the node distance array G32 and the edge distance array G31. Each of the generated thread stores the sum(s) of the element of the node distance array G32 corresponding to the node of which the thread is in charge and the element(s) of the edge distance array G31 corresponding to an edge(s) connecting the node of which the thread is in charge and an adjacent node(s) thereto into the element(s) of the node updating distance array G33 corresponding to the adjacent node(s) to the node of which the thread is in charge (step S35).

Next, the GPU control program 13 generates, in the GPU 61, as many threads that update distance information and path information of the respective nodes in the graph as the number of graph nodes (step S36).

Each of the generated threads refers to the element of the node distance array G32 and the element of the node updating distance array G33 corresponding to the node in the graph for which the thread is in charge of calculation. When the element of the node updating distance array G33 is smaller than the element of the node distance array G32, the generated thread updates the element of the node distance array G32 with the value of the element of the node updating distance array G33 (step S37).

When each thread has performed an update, the thread sets the element of the update array G35 corresponding to the node of which the thread is in charge (step S38). Further, the thread stores the last node before the node of which the thread is in charge in the path corresponding to the updated distance into an element of the path array G34.

Next, when an element(s) set in the update array G35 in step S38 exist(s) (Yes in step S39), the GPU control program 13 returns to the processing in step S34. On the other hand, when no set element exists (No in step S39), the GPU control program 13 ends the calculations because shortest distances and shortest paths from the start node A have been obtained for all the node.

### CITATION LIST

### Non Patent Literature

[NPL 1]: P. Harish and P. J. Narayanan, “Accelerating Large Graph Algorithms on the GPU Using CUDA,” 14th International Conference, Goa, India, Dec. 18-21, 2007, pp. 197-208.

### SUMMARY OF INVENTION

### Technical Problem

It should be noted that all the disclosures of the above-described non patent literature are hereby incorporated herein by reference. The following analysis is made by the present inventors.

According to the path calculation device of the above-described related technology, there is a problem in that path calculations using an accelerator cannot be performed in a high speed manner. That is because an overhead is produced due to wrong distance information propagating first to cause a useless calculation and due to useless threads that do not perform a calculation being generated when the number of updated nodes is small.

According to the path calculation device of the above-described related technology, there is also a problem in that path calculations using a plurality of accelerators cannot be performed in a high speed manner. That is because it is not possible to distribute a calculation load equally across the plurality of accelerators.

Accordingly, it is desired to achieve a speed-up in path calculations using accelerators. An object of the present invention is to prove a path calculation device, a path calculation method, and a program that contribute to achieving the desired speed-up.

### Solution to Problem

A path calculation device according to a first aspect of the present invention includes a calculation means for performing assigned processing in parallel using a plurality of threads; and a control means for controlling the calculation means, wherein the control means: divides nodes that are included in a graph which is object of path calculation, into groups in accordance with distances from a start node; and causes the calculation means to perform path calculations between the start node and nodes belonging to a group of nodes to which distances from the start node are relatively short and thereafter to perform path calculations between the start node and nodes belonging to a group of nodes to which distances from the start node are relatively long.

A path calculation device according to a second aspect of the present invention includes: a calculation means for performing assigned processing in parallel using a plurality of threads; and a control means for controlling the calculation means, wherein the control means, depending on whether or not the number of nodes, to which distances from the start node are to be updated among nodes included in a graph which is object of path calculation, is greater than or equal to a predetermined number, causes the calculation means either to generate threads that update distances from the start node to all nodes included in the graph, or to generate threads that update distances from the start node to nodes to which distances from the start node have a possibility of being updated.

A path calculation method according to a third aspect of the present invention includes the steps of: by a control means that controls a calculation means for performing assigned processing in parallel using a plurality of threads, dividing nodes that are included in a graph which is object of path calculation into groups in accordance with distances from a start node, and causing the calculation means to perform path calculations between the start node and nodes belonging to a group of nodes to which distances from the start node are relatively short and thereafter to perform path calculations between the start node and nodes belonging to a group of nodes to which distances from the start node are relatively long.

A program according to a fourth aspect of the present invention allows a computer, which controls a calculation means for performing assigned processing in parallel using a plurality of threads, to execute: processing for dividing nodes that are included in a graph which is object of path calculation, into groups in accordance with distances from a start node, and processing for causing the calculation means to perform path calculations between the start node and nodes belonging to a group of nodes to which distances from the start node are relatively short and thereafter to perform path calculations between the start node and nodes belonging to a group of nodes to which distances from the start node are relatively long.

The program may be provided as the computer program product which is stored in a non-transitory computer-readable storage medium.

### Advantageous Effects of Invention

A path calculation device, a path calculation method, and a program according to the present invention enable path calculations using accelerators to be speeded up.

### BRIEF DESCRIPTION OF DRAWINGS

FIG. 1 is a block diagram illustrating a configuration of a path calculation device according to one exemplary embodiment as an example;

FIG. 2 is a block diagram illustrating a configuration of a path calculation device according to a first exemplary embodiment as an example;

FIG. 3 is a diagram illustrating a configuration of graph data that the path calculation device according to the first exemplary embodiment includes as an example;

FIG. 4 is a diagram for a description of an operation of the path calculation device according to the first exemplary embodiment;

FIG. 5 is a flowchart illustrating the operation of the path calculation device according to the first exemplary embodiment as an example;

FIG. 6 is a block diagram illustrating a configuration of a path calculation device according to a second exemplary embodiment as an example;

FIG. 7 is a diagram illustrating graph data that the path calculation device according to the second exemplary embodiment includes as an example;

FIG. 8 is a diagram for a description an operation of the path calculation device according to the second exemplary embodiment;

FIG. 9 is a flowchart illustrating the operation of the path calculation device according to the second exemplary embodiment as an example;

FIG. 10 is a block diagram illustrating a configuration of a path calculation device of a related technology as an example;

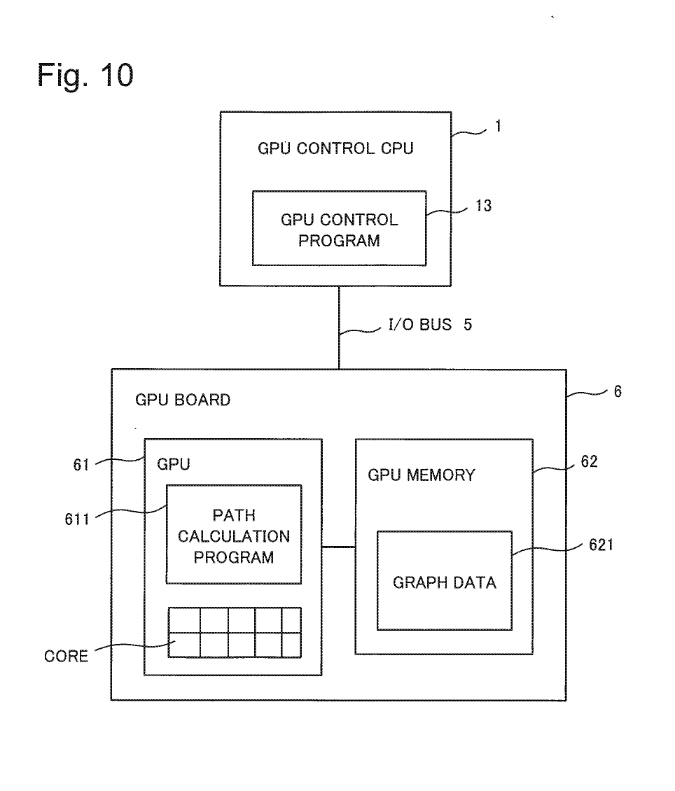

FIG. 11 is a diagram illustrating a configuration of graph data that the path calculation device of the related technology includes as an example; and

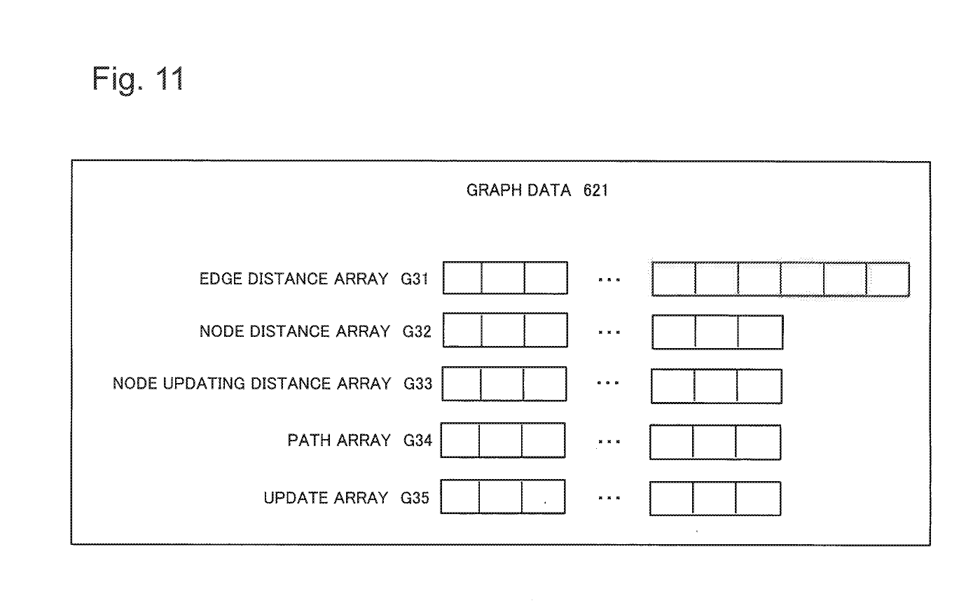

FIG. 12 is a flowchart illustrating an operation of the path calculation device of the related technology as an example.

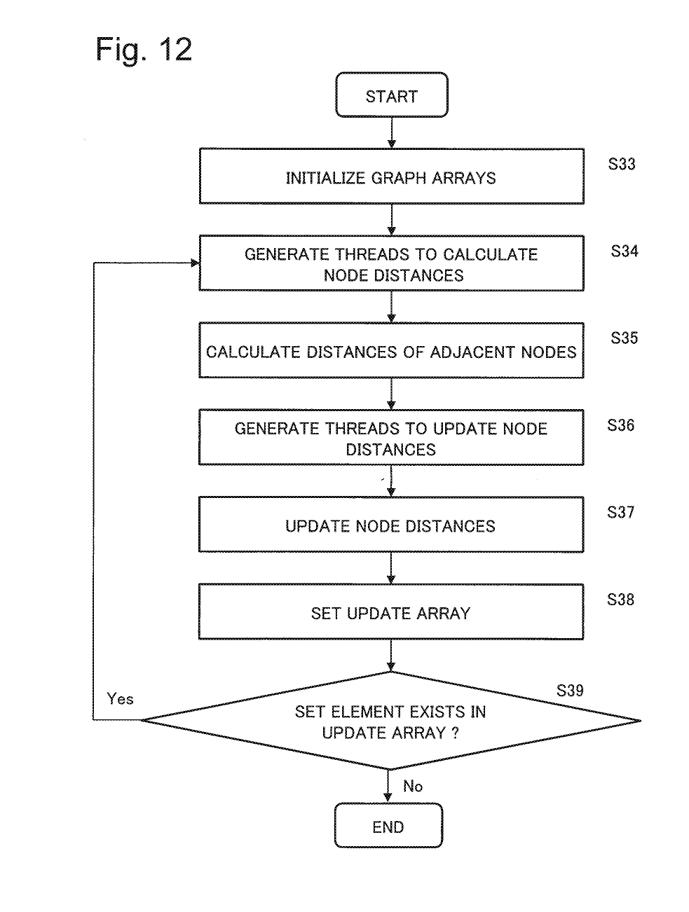

### DESCRIPTION OF EMBODIMENTS

First, an outline of one exemplary embodiment will be described. Reference symbols of drawings described in this outline are shown solely as examples in order to assist understanding, and are not intended to limit the present invention to the modes in the drawings.

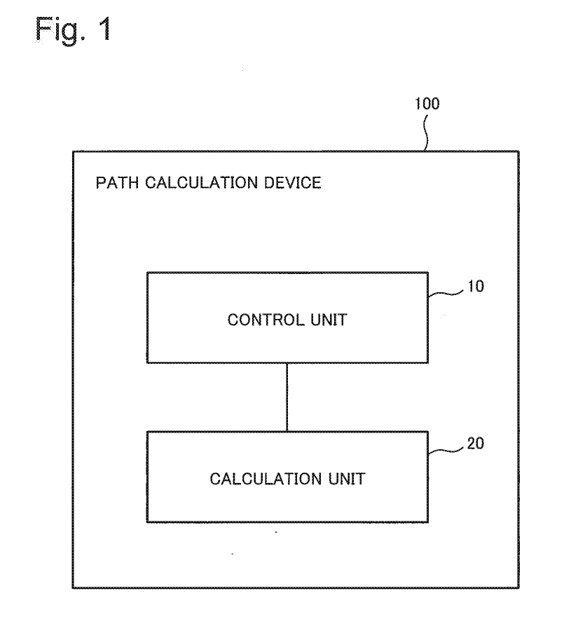

With reference to FIG. 1, a path calculation device 100 according to one exemplary embodiment includes a calculation means 20 that performs assigned processing in parallel using a plurality of threads and a control means 10 that controls the calculation means 20. The control means 10 divides nodes that are included in a graph which is object of path calculation into groups in accordance with distances from a start node to the nodes. As an example, the control means 10 may divide the nodes included in the graph into different groups for each integer multiple of a predetermined parameter in accordance with distances from the start node to the nodes. The control means 10 causes the calculation means 20 to first perform path calculations between the start node and nodes belonging to a group of nodes to which distances from the start node are relatively short and thereafter perform path calculations between the start node and nodes belonging to a group of nodes to which distances from the start node are relatively long.

Further, depending on whether or not the number of nodes to which from distances the start node are to be updated among the nodes included in the graph is greater than a predetermined number, the control means 10 may cause the calculation means 20 to generate threads that update the distances from the start node for all the nodes included in the graph, or, generate threads that update the distances from the start node for nodes to which distances from the start node have a possibility to be updated.

Such a configuration enables the prevention of production of an overhead related to wrong path information which first propagates to cause a useless calculation. An overhead due to generation of useless threads that do not update information can also be prevented from being produced. That is, such a configuration enables the prevention of production of not only an overhead due to wrong distance information propagating first to cause a useless calculation but also an overhead due to useless threads that do not perform calculations being generated when the number of nodes to be updated is small. Therefore, the path calculation device according to one exemplary embodiment enables path calculations using accelerators to be performed in a high speed manner.

### First Exemplary Embodiment

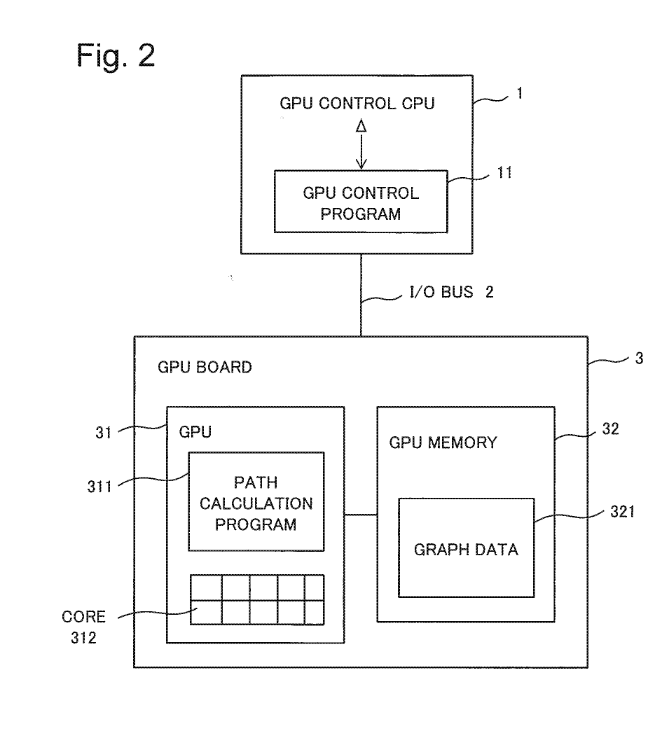

A path calculation device according to a first exemplary embodiment will be described in detail with reference to the drawings. With reference to FIG. 2, the path calculation device of the exemplary embodiment includes a GPU control CPU 1, which controls a GPU, and a GPU board 3.

In the GPU control CPU 1, a GPU control program 11 runs. The GPU control CPU 1 and the GPU board 3 are interconnected by an I/O bus 2. The GPU control program 11 receives a parameter Δ (delta), which is used in steps in path calculations, as an input value at activation.

The GPU board 3 includes a GPU 31 that performs path calculations and a GPU memory 32 that stores graph data 321. In the GPU 31, a path calculation program 311 that performs path calculations runs.

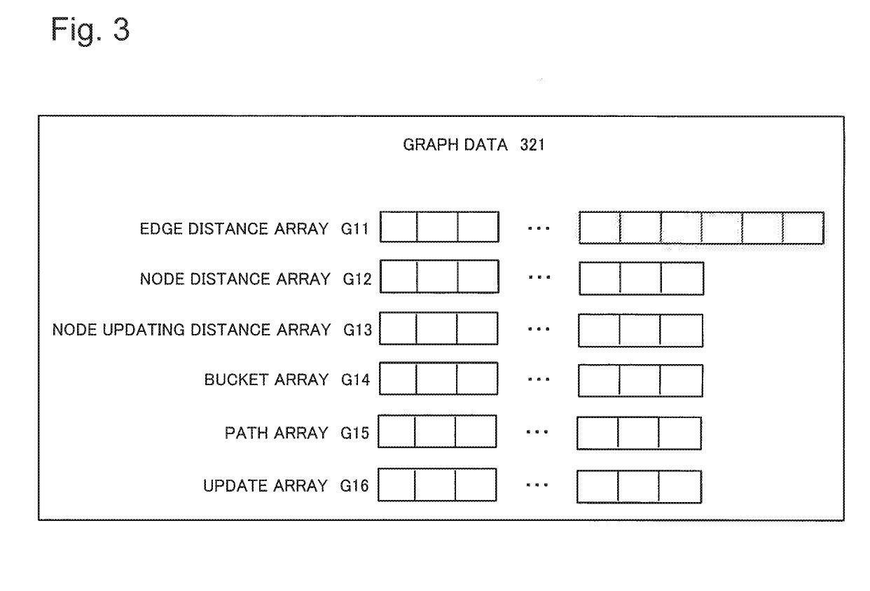

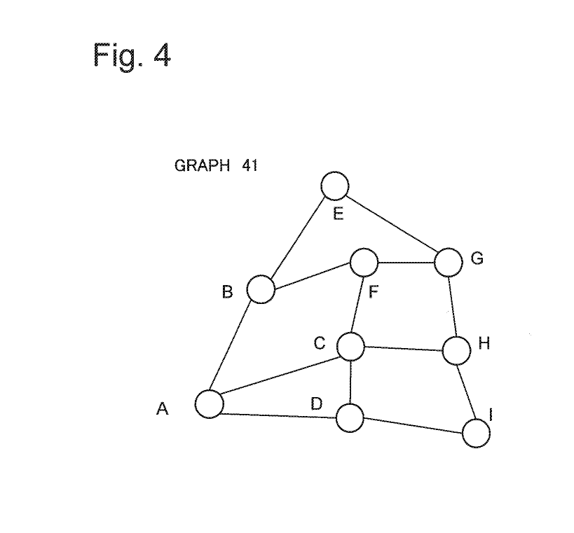

The graph data 321 that the GPU memory 32 stores are illustrated in FIG. 3. In the following description, it is assumed, as an example, that the graph data 321 are data that correspond to a graph 41 illustrated in FIG. 4. The graph data 321 contain an edge distance array G11 that contains costs of edges between respective nodes in a graph. The graph data 321 contain a node distance array G12 that contains distances from a start node to all the nodes in the graph for which path calculations are performed. The graph data 321 contain a node updating distance array G13 that contains updating values of the node distance array. The graph data 321 contain a bucket array G14 that contains the bucket numbers of the respective nodes at a current time. The graph data 321 contain a path array G15 each element of which indicates the last node before each node in the shortest path of the node from the start node. The graph data 321 contain an update array G16 each element of which indicates whether or not a distance has been updated at each node in path calculations.

The number of elements of the edge distance array G11 is equal to the number of edges in the graph 41. The number of elements in each of the node distance array G12, the node updating distance array G13, the bucket array G14, the path array G15, and the update array G16 is equal to the number of nodes in the graph 41.

The GPU 31 includes a plurality of cores 312 that perform calculations. The GPU 31 achieves a speed-up of path calculations by means of performing calculations in parallel using the plurality of cores 312.

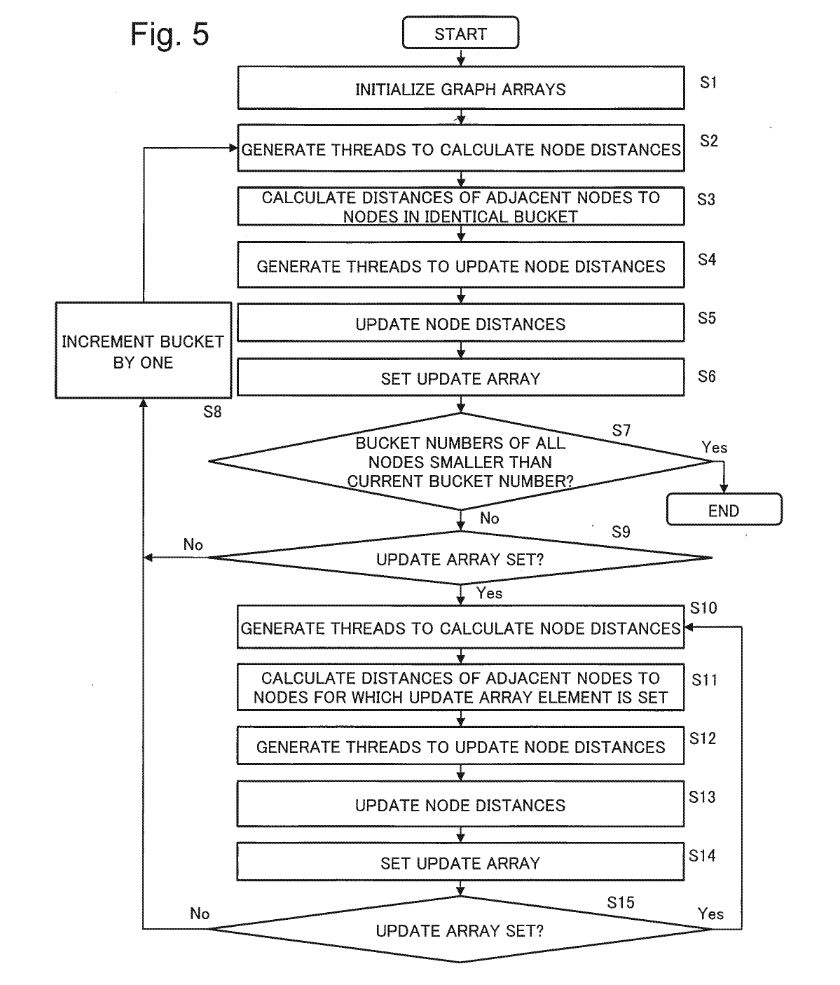

An operation of the first exemplary embodiment having such a configuration will be described using the accompanying drawings. FIG. 5 is a flowchart illustrating an operation of the path calculation device according to the first exemplary embodiment as an example. In the following description, it is assumed that, in the graph 41 in FIG. 4, distances and shortest paths starting from a node A are to be obtained for all the nodes (A to I) in the graph.

First, the GPU control program 11 initializes the distance of the start node A to 0 (zero) and the distances of the other nodes B to I to infinity in the node distance array G12 in the GPU memory 32. The GPU control program 11 also initializes the element of the bucket array G14 corresponding to the start node A to 0 (zero) and the elements thereof corresponding to the other nodes to infinity (step S1).

Next, the GPU control program 11 generates, in the GPU 31, as many threads that perform path calculations for the respective nodes in the graph in the path calculation program 311 as the number of nodes in the graph. To the threads, a bucket number for which calculation is currently under way is passed (step S2). In the initial calculation, the bucket number is 0 (zero).

Each of the generated threads runs in one of the cores 312 in the GPU 31. Each of the generated threads refers to the element of the bucket array G14 corresponding to the node in the graph for which the thread is in charge of calculation and confirms whether or not that the value of the element is identical to the value passed by the GPU control program 11 at the activation of the thread. When the values are identical to each other, each of the generated threads refers to the node distance array G12 and the edge distance array G11. Each thread stores the sum(s) of the element of the node distance array G12 corresponding to the node of which the thread is in charge and the element(s) of the edge distance array G11 corresponding to an edge(s) connecting the node of which the thread is in charge and an adjacent node(s) thereto into the element(s) of the node updating distance array G13 corresponding to the adjacent node(s) (step S3).

Next, the GPU control program 11 generates, in the GPU 31, as many threads that update distance information and path information of the respective nodes in the graph in the path calculation program 311 as the number of nodes in the graph (step S4). At this time, to the generated threads, the bucket number for which calculation is currently under way and the parameter Δ passed to the GPU control program 11 at the activation thereof are passed.

Each of the generated thread refers to the element of the node distance array G12 and the element of the node updating distance array G13 corresponding to the node in the graph for which the thread is in charge of calculation. When the element of the node updating distance array G13 is smaller than the element of the node distance array G12, the thread updates the element of the node distance array G12 with the value of the element of the node updating distance array G13. The thread stores the last node before the node of which the thread is in charge in the path corresponding to the updated distance into an element of the path array G15. The thread stores the integer portion of a value obtained by dividing the value that the thread has updated by A into the element of the bucket array G14 corresponding to the node that the thread has updated as a new bucket number (step S5).

Subsequently, when a value in the bucket array G14 that each thread has stored is identical to the bucket number for which calculation is currently under way, the thread sets the element of the update array G16 corresponding to the node that the thread has updated (step S6).

Next, when the GPU control program 11 is notified that no node having a bucket number equal to or greater than the bucket number for which calculation is currently under way exists among all the nodes in the graph of which the threads generated in step S2 or S4 are in charge (Yes in step S7), the GPU control program 11 ends the path calculations because the notification means the completion of the path calculations.

When no element of the update array G16 that has been set in step S6 exists (No in step S9), the GPU control program 11 increments the bucket number for which calculation is performed by one (step S8) and returns to the processing in step S2.

On the other hand, when an element(s) of the update array G16 that has/have been set exist(s) (Yes in step S9), the GPU control program 11 proceeds to the processing in step S10 to update the distance(s) of a node(s) in the same bucket.

In step S10, the GPU control program 11 generates, in the GPU 31, as many threads that perform path calculations for the respective nodes in the graph in the path calculation program 311 as the number of nodes in the graph.

Each of the generated threads runs in one of the cores 312 in the GPU 31. Each thread refers to the element of the update array G16 corresponding to the node in the graph for which the thread is in charge of calculation and, when the element has been set, refers to the node distance array G12 and the edge distance array G11. The thread stores the sum of the element of the node distance array G12 corresponding to the node of which the thread is in charge and the element of the edge distance array G11 corresponding to an edge connecting the node of which the thread is in charge and an adjacent node thereto into the element of a node updating array corresponding to the adjacent node (step S11).

Next, the GPU control program 11 generates, in the GPU 31, as many threads that update distance information and path information of the respective nodes in the graph in the path calculation program 311 as the number of nodes in the graph (step S12).

At this time, the bucket number for which calculation is currently under way and Δ passed to the GPU control program 11 at the activation thereof are passed to the generated thread. The generated thread refers to the element of the node distance array G12 and the element of the node updating distance array G13 corresponding to the node in the graph for which the thread is in charge of calculation. When the referenced element of the node updating distance array G13 is smaller than the referenced element of the node distance array G12, the thread updates the element of the node distance array G12 with the value of the element of the node updating distance array G13. The thread stores the last node before the node of which the thread is in charge in the path corresponding to the updated distance into an element of the path array G15. The thread also stores the integer portion of a value obtained by dividing the value that the thread has updated by Δ into the element of the bucket array G14 corresponding to the node that the thread has updated as a new bucket number (step S13).

Subsequently, when a value in the bucket array G14 that each thread has stored is identical to the bucket number for which calculation is currently under way, the thread sets the element of the update array G16 corresponding to the node that the thread has updated (step S14).

Next, when an element of the update array G16 that has been set in step S14 exists (Yes in step S15), the GPU control program 11 returns to the processing in step S10. On the other hand, when no element of the update array G16 that has been set in step S14 exists (No in step S15), the GPU control program 11 increments the bucket number by one (step S8) and returns to the processing in step S2.

As described above, in the exemplary embodiment, the GPU control program 11 divides nodes which are object of path calculation into groups for each integer multiple of a parameter Δ (delta) passed at activation in accordance with distances from a start node. The GPU control program 11 performs path calculations within the same group in parallel, and performs path calculations for a succeeding group after calculations for a preceding group have been completed. In calculations within the same group, the GPU control program 11 selects whether to generate as many threads as required to perform calculations for all the nodes in the graph or to generate threads limited to nodes to be updated, depending on the number of nodes the distances of which are to be updated.

Such a configuration is able to limit nodes of which information is to be updated within a bucket, with regard to calculations for shortest distances and paths from a start node. Performing calculations in parallel for such limited nodes within a bucket enables wrong information of shortest distances and paths to be prevented from propagating to farther nodes than the nodes in the bucket for which calculations are currently under way, and causing useless calculations therefor to be performed. This enables a path calculation time to be reduced. In particular, according to the exemplary embodiment, a path calculation device using an accelerator is provided that is capable of obtaining shortest paths and distances from a point in a graph to all the points in the graph in a high speed manner.

### Second Exemplary Embodiment

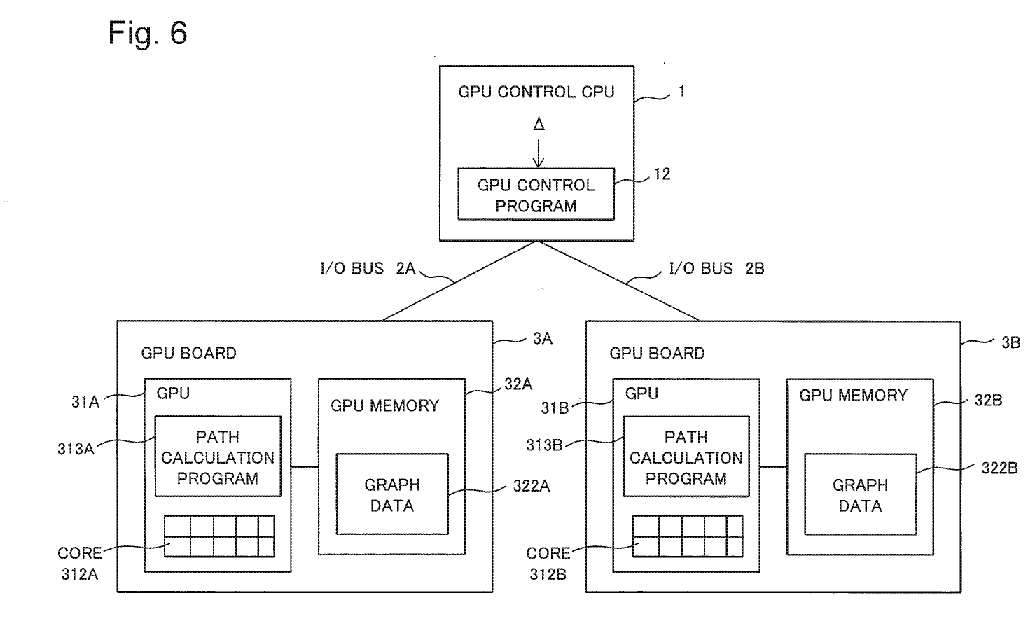

Next, a path calculation device according to a second exemplary embodiment will be described with reference to the accompanying drawings. The path calculation device of the exemplary embodiment performs path calculations for a graph using a plurality of GPUs. With reference to FIG. 6, the path calculation device of the exemplary embodiment includes a GPU board 3A and a GPU board 3B as GPUs to perform calculations.

Hereinafter, A and B indicate suffix to discriminate a plurality of GPU boards from each other. Although, for the convenience of description, a case in which two GPUs are used will be described in the following, the present invention is applicable to not only the case of using two GPUs but also cases in which three or more GPUs are used.

With reference to FIG. 6, the path calculation device of the exemplary embodiment includes a GPU control CPU 1 that controls GPUs, the GPU board 3A, and the GPU board 3B. Hereinafter, when the same description applies to both a GPU 3A and a GPU 3B or an operation of the GPU 3B is the same as an operation of the GPU 3A, a description for the GPU 3B will be omitted.

In the GPU control CPU 1, a GPU control program 12 runs. The GPU control CPU 1 and the GPU board 3A are interconnected by an I/O bus 2A. The GPU control program 12 receives a parameter Δ (delta), which is used in steps in path calculations, as an input value at activation.

The GPU board 3A includes a GPU 31A that performs path calculations and a GPU memory 32A that stores graph data 322A.

In the GPU 31A, a path calculation program 313A that performs path calculations runs.

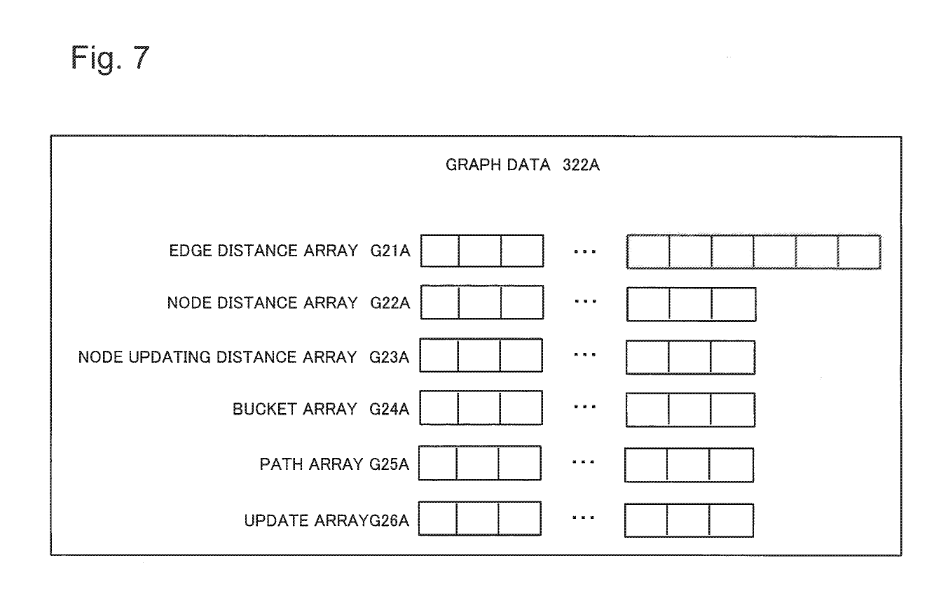

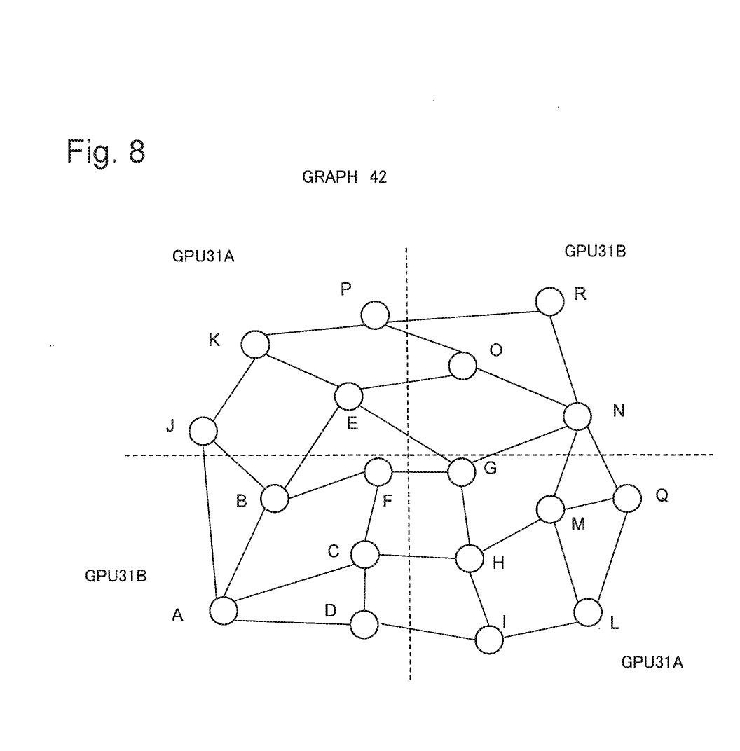

The graph data 322A that the GPU memory 32A stores are illustrated in FIG. 7. In the following description, it is assumed, as an example, that the graph data 322A are data that correspond to a graph 42 illustrated in FIG. 8. The data with regard to the graph 42 are divided and stored in the respective GPUs.

When a graph is divided into as many regions as the number of GPUs and each region is simply allocated to a GPU, since distance information is updated for nodes closer to a start node first in path calculations, a load on processing becomes uneven, such as, in an earlier stage of path calculations, only a GPU to which a region including nodes closer to the start node is allocated performs calculation. Thus, in the exemplary embodiment, the graph 42 is divided into a greater or equal number of regions than the number of GPUs and the respective regions are allocated to the GPUs at random.

The graph 42 in FIG. 8 is divided into four regions, and the respective regions are allocated to the GPU 31A or GPU 31B at random. In this case, the graph data 322A contain, in addition to information on nodes in the region(s) in the graph of which the GPU 31A is in charge, information on edges that cross a boundary between regions and information on nodes that are connected by the edges crossing a boundary and of which the GPU 31B is in charge.

The graph data 322A contain an edge distance array G21A that contains costs of edges between respective nodes and edges crossing a boundary in a graph region(s) of which the GPU 31A is in charge. The graph data 322A contain a node distance array G22A that contains distances from the respective nodes within the graph regions(s) of which the GPU 31A is in charge to a start node. The graph data 322A contain a node updating distance array G23A that contains updating values of the node distance array G22A.

The node updating distance array G23A has, in addition to the elements corresponding to graph nodes of which the GPU 31A is in charge, elements to store updating values provided by the GPU 31B with respect to nodes connected by edges to nodes of which the GPU 31B is in charge among the graph nodes of which the GPU 31A is in charge. The node updating distance array G23A also has elements to store updating values for nodes of which the GPU 31B is in charge and to which graph nodes of which the GPU 31A is in charge are connected by edges.

The graph data 322A also contain a bucket array G24A that contains the bucket numbers of the graph nodes of which the GPU 31A is in charge at a current time. The graph data 322A contain a path array G25A each element of which indicates the last node before each node of which the GPU 31A is in charge in the shortest path of the node from the start node. The graph data 322A contain an update array G26A each element of which indicates whether or not a distance has been updated at each node of which the GPU 31A is in charge in path calculations.

The number of elements in the edge distance array G21A is equal to the total sum of the numbers of edges within the graph region(s) of which the GPU 31A is in charge and edges crossing a boundary of the graph region(s) of which the GPU 31A is in charge. On the other hand, the number of elements in the node distance array G22A is equal to the total sum of the number of nodes in the graph region(s) of which the GPU 31A is in charge, the number of elements to store updating values provided by the GPU 31B (the number of nodes connected by edges to nodes of which the GPU 31B is in charge among the nodes of which the GPU 31A is in charge), and the number of elements to record updating values for nodes of which the GPU 31B is in charge (the number of nodes connected by edges to nodes of which the GPU 31A is in charge among the nodes of which the GPU 31B is in charge). The number of elements in each of the node updating distance array G23A, the bucket array G24A, the path array G25A, and the update array G26A is equal to the number of nodes in the graph 42 of which the GPU 31A is in charge.

The GPU 31A includes a plurality of cores 312A that perform calculations. The GPU 31A achieves a speed-up of the path calculations by means of performing calculations in parallel using the plurality of cores 312A.

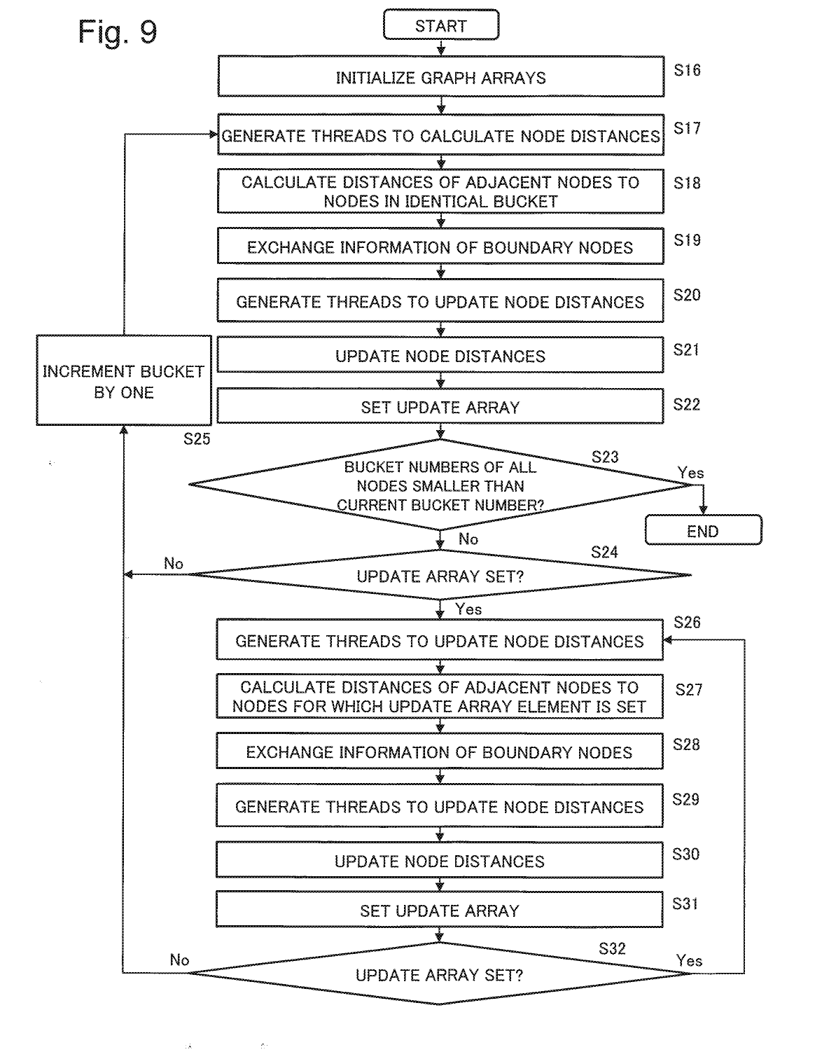

An operation of the second exemplary embodiment having such a configuration will be described with reference to the drawings. FIG. 9 is a flowchart illustrating an operation of the second exemplary embodiment as an example. In the following description, it is assumed, as an example, that, in the graph in FIG. 8, distances and shortest paths starting from a node A are to be obtained for all the nodes (A to R) in the graph.

First, the GPU control program 12 initializes the distance of the start node A to 0 (zero) and the distances of the other nodes B to R to infinity in the node distance array G22A and a node distance array G22B stored in the GPU memory 32A and the GPU memory 32B, respectively. The GPU control program 12 also initializes the elements of the bucket array G24A and a bucket array G24B corresponding to the start node A to 0 (zero) and the elements therein corresponding to the other nodes to infinity (step S16).

Next, the GPU control program 12 generates, in the GPU 31A and the GPU 31B, as many threads that perform path calculations for the respective nodes in the graph in the path calculation program 313A and a path calculation program 313B as the number of graph nodes, respectively. In this processing, the number of threads generated in the GPU 31A is equal to the number of nodes in the regions(s) in the graph of which the GPU 31A is in charge. To the generated threads, a bucket number for which calculation is currently under way is passed (step S17).

Hereinafter, when descriptions with regard to the GPU 31A and the GPU 31B overlap each other, only a description with regard to the GPU 31A will be made and a description with regard to the GPU 31B will be omitted.

In the initial calculation, the bucket number is equal to 0 (zero). Each of the generated threads runs in one of the cores 312A in the GPU 31A. Each of such threads refers to the element of the bucket array G24A corresponding to the node in the graph for which the thread is in charge of calculation and confirms whether or not the value of the element is identical to the value passed by the GPU control program 12 at the activation of the thread. When the values are identical to each other, such a thread, referring to the node distance array G22A and the edge distance array G21A, stores the sum of the element of the node distance array G22A corresponding to the node of which the thread is in charge and the element of the edge distance array G21A corresponding to an edge connecting the node of which the thread is in charge and an adjacent node thereto into the element of a node updating array corresponding to the adjacent node (step S18).

Next, the GPU control program 12 exchanges information on boundary nodes among updating information that the respective graph boards have calculated between the graph boards. With regard to information transferred from the GPU board 3A to the GPU board 3B, the elements of the node updating distance array G23A corresponding to nodes in the graph region(s) of which the GPU 31B is in charge are stored into elements for registration of updating information from the GPU 31A in a node updating distance array G23B (not illustrated) that the graph data 322B contain (step S19).

Next, the GPU control program 12 generates, in the GPU 31A, as many threads that update distance information and path information of the nodes in the graph region(s) of which the GPU 31A is in charge in the path calculation program 313A as the number of nodes of which the GPU 31A is in charge (step S20) (the same step applies to the GPU board 3B). At this time, to the generated threads, a bucket number for which calculation is currently under way and A passed to the GPU control program 12 at the activation thereof are passed.

The generated thread refers to the element of the node distance array G22A and the element of the node updating distance array G23A corresponding to the node in the graph for which the thread is in charge of calculation. When the element of the node updating distance array G23A is smaller than the element of the node distance array G22A, the thread updates the element of the node distance array G22A with the value of the element of the node updating distance array G23A. At this time, when the node of which the thread is in charge is a node connected by an edge to a node of which the GPU 31B is in charge, the thread refers to both an element stored by the GPU 31A in step S18 and an element stored by the GPU 31B in step S19 in the node updating distance array G23A to select the smaller value therefrom. The path calculation program 313A stores the last node before the node for which the thread is in charge of calculation in the path corresponding to the updated distance into an element of the path array G25A. Further, such a thread stores the integer portion of a value obtained by dividing the value that the thread has updated by Δ into the element of the bucket array G24A corresponding to the node the distance to which the thread has updated as a new bucket number (step S21).

Subsequently, when a value that each thread has stored in the bucket array G24A is identical to the bucket number for which calculation is currently under way, the thread sets the element of the update array G26A corresponding to the node the distance to which the thread has updated (step S22).

Next, when the GPU control program 12 is notified that no node having a bucket number greater than or equal to the bucket number for which calculation is currently under way exists among the graph nodes of which all the threads generated in step S17 or step S20 to perform processing in the path calculation programs 313A and 313B are in charge (Yes in step S23), the GPU control program 12 ends the path calculations because such a notification means the completion of the path calculations.

When no element of the update array G26A that has been set in step S22 exists (No in step S24), the GPU control program 12 increments the bucket number for which calculation is performed by one (step S25) and returns to the processing in step S17.

On the other hand, when an element of the update array G26A that has been set exists (Yes in step S24), the GPU control program 12 proceeds to the processing in step S26 to update the distance of a nodes in the same bucket. In step S24, the GPU control program 12 decides “Yes” when either an element of the update array G26A or an element of an update array G26B is set and proceeds to step S26.

In step S26, the GPU control program 12 generates, in the GPU 31A, as many threads that perform path calculations for the nodes of which the GPU 31A is in charge as the number of nodes in the region(s) of which the GPU 31A is in charge and makes the path calculation program 313A run therein (step S26) (the same step applied to the GPU board 3B). Each of the generated threads for the path calculation program 313A runs in one of the cores 312A in the GPU 31A.

The path calculation program 313A refers to the element of the update array G26A corresponding to the node in the graph for which each thread is in charge of calculation and, when the element has been set, refers to the node distance array G22A and the edge distance array G21A. The path calculation program 313A stores the sum of the element of the node distance array G22A corresponding to the node of which the thread is in charge and the element of the edge distance array G21A corresponding to an edge connecting the node of which the thread is in charge and an adjacent node thereto into the element of the node updating distance array G23A corresponding to the adjacent node (step S27).

Next, the GPU control program 12 exchanges information on boundary nodes among updating information that the respective graph boards have calculated between the graph boards (step S28). Information that is transferred from the GPU board 3A to the GPU board 3B is the elements of the node updating distance array G23A corresponding to nodes in the graph region(s) of which the GPU 31B is in charge. Such data are stored in elements to store updating information provided by the GPU 31A among the elements of the node updating distance array G23B that the graph data 322B contain.

Next, the GPU control program 12 generates, in the GPU 31A, as many threads that perform processing of the path calculation program 313A to update distance information and path information of the respective nodes in the graph regions(s) of which the GPU 31A is in charge as the number of nodes in the graph regions(s) (step S29). At this time, to the generated threads, the bucket number for which calculation is currently under way and A passed to the GPU control program 12 at the activation thereof are passed.

Each of the generated threads for the path calculation program 313A refers to the element of the node distance array G22A and the element of the node updating distance array G23A corresponding to the node in the graph for which the thread is in charge of calculation. When the element of the node updating distance array G23A is smaller than the element of the node distance array G22A, the thread updates the element of the node distance array G22A with the value of the element of the node updating distance array G23A. At this time, with regard to nodes connected by edges to nodes of which the GPU 31B is in charge, the thread is required to refer to both an element stored by the GPU 31A in step S27 and an element stored by the GPU 31B in step S28 in the node updating distance array G23A to select the smaller value therefrom. The thread stores the last node before the node of which the thread is in charge in the path corresponding to the updated distance into an element of the path array G25A. The thread also stores the integer portion of a value obtained by dividing the value that the thread has updated by A into the element of the bucket array G24A corresponding to the node that the thread has updated as a new bucket number (step S30).

Subsequently, when a value in the bucket array G24A that each thread has stored is identical to the bucket number for which calculation is currently under way, the thread sets the element of the update array G26A corresponding to the node that the thread has updated (step S31).

Next, when an element(s) that has/have been set in step S31 exist(s) in either the update array G26A or the update array G26B (Yes in step S32), the GPU control program 12 returns to the processing in step S26. On the other hand, when an element that has been set in step S31 exists in neither the update array G26A nor the update array G26B (No in step S32), the GPU control program 12 increments the bucket number by one (step S25) and returns to the processing in step S17.

In the second exemplary embodiment employing such a configuration, nodes for which information is updated are restricted to nodes within a bucket in the calculation of shortest distances and paths from a start node. Applying parallel calculations to such nodes prevents wrong information of shortest distances and paths from propagating to farther nodes than nodes in the bucket for which calculation is currently under way to cause useless calculations of shortest distances and paths to be performed. According to the second exemplary embodiment, such a configuration enables a path calculation time to be reduced.

Further, in the second exemplary embodiment, the region of a graph is divided into a greater or equal number of regions than GPUs in which calculations are performed, and the respective regions are allocated to a plurality of GPUs at random. With this configuration, in the second exemplary embodiment, distributing a calculation load on path calculations equally across a plurality of GPUs enables the path calculation time to be further reduced.

That is, according to the exemplary embodiment, since a load on calculation processing can be equalized among a plurality of accelerators, it becomes possible to perform calculations in a high speed manner in path calculations using the plurality of accelerators.

### Third Exemplary Embodiment

Next, a path calculation device according to a third exemplary embodiment will be described. While, in the first and second exemplary embodiments, threads to perform calculations for all the nodes in a graph are generated in steps S10 and S26, it is also possible to generate only threads corresponding to nodes in the graph the distance information of which has a possibility of being updated.

In this case, the element numbers of elements to be set in the update array and the number of such elements are recorded in steps S6, S14, S22, and S31, and threads to be generated in the succeeding steps S10 and S26 are restricted to the threads for the nodes corresponding to the elements of the update array that have been set.

Such a configuration enables an overhead caused by threads for nodes in a graph the distance information of which is not updated being generated in steps S10 and S26 to be reduced.

### Fourth Exemplary Embodiment

Next, a path calculation device according to a fourth exemplary embodiment will be described.

In the third exemplary embodiment, threads are generated for only nodes in a graph the distance information of which is updated. On the other hand, a method may be employed that includes, in steps S10 and S26, when the number of nodes to be updated is greater than or equal to a certain number, generating threads corresponding to all the nodes in a graph, and, otherwise, generating only the threads corresponding to nodes to be updated.

Measurement of the number of nodes to be updated may be achieved by counting the number of elements in an update array that are set in steps S6, S14, S22, and S31.

As another method, when, for example, the processing in step S10 is repeated due to “Yes” decisions in step S15, it is possible to predict the number of nodes in a graph to be updated in a present round of processing on the basis of the total time taken to perform a previous round of processing from steps S10 to S14.

For example, when the total time taken to perform a previous round of processing from steps S10 to S14 is longer or equal to a time prescribed by a threshold value, threads to perform calculations for all the nodes in a graph are generated in step S10 on the basis of a prediction that updates for a greater or equal number of nodes than a certain number are to be performed in a present round of calculation. On the other hand, when the total time taken to perform the previous round of processing from steps S10 to S14 is shorter or equal to the time prescribed by the threshold value, only the threads corresponding to nodes in the graph for which updates are performed are generated on the basis of a prediction that updates for a less or equal number of nodes than the certain number are to be performed.

With this configuration, when the number of nodes to be updated is substantial, it is possible to reduce an overhead caused by processing to count the number of nodes to be updated.

Although, in the description of the exemplary embodiments thus far, methods in which GPUs are used as accelerators were described, it is also possible to use accelerators of another type having a plurality of calculation cores, such as Xeon Phi produced by Intel Corporation.

The present invention is applicable to various uses, such as a computer performing path calculations and a program to achieve a computer performing path calculations. The present invention is also applicable to uses, such as a service to perform path calculations via the Internet and a program to achieve such a service. The present invention is also applicable to uses, such as an apparatus to perform navigation and a program to achieve such an apparatus.

The present invention may be embodied in the following modes.

### [Mode 1]

A path calculation device according to the above-described first aspect.

### [Mode 2]

The path calculation device according to Mode 1, wherein

the control means divides nodes included in the graph into different groups for each integer multiple of a predetermined parameter in accordance with distances from the start node.

### [Mode 3]

The path calculation device according to Mode 1 or 2, wherein

the control means, depending on whether or not the number of nodes, to which distances from the start node are to be updated among nodes included in the graph, is greater than or equal to a predetermined number, causes the calculation means either to generate threads that update distances from the start node to all nodes included in the graph, or to generate threads that update distances from the start node to nodes to which distances from the start node have a possibility of being updated.

### [Mode 4]

The path calculation device according to Mode 3, wherein

the control means predicts the number of nodes to which distances from the start node are to be updated, on the basis of a processing time taken to perform the previous round of update processing.

### [Mode 5]

The path calculation device according to any one of Modes 1 to 4, including:

a plurality of the calculation means,

wherein the control means:
divides the graph into a plurality of regions by a number greater than the number of the plurality of the calculation means;

allocates the plurality of regions to the plurality of the calculation means at random; and

causes the plurality of the calculation means to perform path calculations between nodes included in the region(s) allocated thereto and the start node.

### [Mode 6]

The path calculation device according to Mode 5, wherein

the control means divides nodes included in each of the plurality of regions into groups in accordance with distances from the start node thereto, and causes the plurality of the the calculation means to perform path calculations between the start node and nodes belonging to a group of nodes to which distances from the start node are relatively short, and thereafter to perform path calculations between the start node and nodes belonging to a group of nodes to which distances from the start node are relatively long.

### [Mode 7]

The path calculation device according to Mode 6, wherein

the control means divides nodes included in each of the plurality of regions into different groups for each integer multiple of a predetermined parameter in accordance with distances from the start node.

### [Mode 8]

The path calculation device according to any one of Modes 5 to 7, wherein

the control means causes the plurality of the calculation means to exchange with each other pieces of information which indicates whether or not distances from the start node to nodes included in the region(s) allocated to the plurality of the calculation means have been updated in the middle of path calculations.

### [Mode 9]

The path calculation device according to any one of Modes 5 to 8,

wherein the control means, depending on whether or not the number of nodes to which distances from the start node are to be updated, among nodes included in a region(s) allocated to the plurality of calculation means is greater than or equal to a predetermined number, causes the plurality of the calculation means either to generate threads that update distances from the start node to all nodes included in the allocated region(s), or to generate threads that update distances from the start node to nodes to which distances from the start node have a possibility of being updated.

### [Mode 10]

The path calculation device according to Mode 9, wherein the control means predicts the number of nodes to which distances from the start node are to be updated among nodes included in the allocated region(s), on the basis of a processing time taken to perform a previous round of update processing.

### [Mode 11]

A path calculation method according to the above-described third aspect.

### [Mode 12]

The path calculation method according to Mode 11, wherein

the control means divides nodes included in the graph into different groups for each integer multiple of a predetermined parameter in accordance with distances from the start node.

### [Mode 13]

The path calculation method according to Mode 11 or 12, further including the steps of:

by the control means, depending on whether or not the number of nodes, to which distances from the start node are to be updated among nodes included in the graph, is greater than or equal to a predetermined number, causing the calculation means either to generate threads that update distances from the start node to all nodes included in the graph, or to generate threads that update distances from the start node to nodes to which distances from the start node have a possibility of being updated.

### [Mode 14]

The path calculation method according to any one of Modes 11 to 13, further including the steps of:

controlling, by the control means, a plurality of the calculation means;

dividing, by the control means, the graph into a plurality of regions by a number greater than the number of the plurality of the calculation means; and

allocating, by the control means, the plurality of regions to the plurality of the calculation means at random and causing the plurality of the calculation means to perform path calculations between nodes included in the region(s) allocated thereto and the start node.

### [Mode 15]

The path calculation method according to Mode 14, further including the steps of:

dividing, by the control means, nodes included in each of the plurality of regions into groups in accordance with distances from the start node thereto; and

causing, by the control means, the plurality of the calculation means to perform path calculations between the start node and nodes belonging to a group of nodes to which distances from the start node are relatively short, and thereafter to perform path calculations between the start node and nodes belonging to a group of nodes to which distances from the start node are relatively long.

### [Mode 16]

The path calculation method according to Mode 14 or 15, further including the steps of:

causing, by the control means, the plurality of the calculation means to exchange with each other pieces of information which indicates whether or not distances from the start node to nodes included in the region(s) allocated to the plurality of the calculation means have been updated, in the middle of path calculations.

### [Mode 17]

A program according to the above-described fourth aspect.

### [Mode 18]

The program according to the Mode 17, wherein the program further allows the computer to execute:

processing for dividing nodes included in the graph into different groups for each integer multiple of a predetermined parameter in accordance with distances from the start node.

### [Mode 19]

The program according to Mode 17 or 18, wherein the program further allows the computer to execute:

depending on whether or not the number of nodes, to which distances from the start node are to be updated among nodes included in the graph, is greater than or equal to a predetermined number, processing for causing the calculation means either to generate threads that update distances from the start node to all nodes included in the graph, or to generate threads that update distances from the start node to nodes to which distances from the start node have a possibility of being updated.

### [Mode 20]

The program according to any one of Mode 17 to 19, wherein the program further allows the computer to execute:

processing for controlling a plurality of the calculation means;

processing for dividing the graph into a plurality of regions by a number greater than the number of the plurality of the calculation means; and

processing for allocating the plurality of regions to the plurality of the calculation means at random and causing the plurality of the calculation means to perform path calculations between nodes included in the region(s) allocated thereto and the start node.

### [Mode 21]

The program according to Mode 20, wherein the program further allows the computer to execute:

processing for dividing nodes included in each of the plurality of regions into groups in accordance with distances from the start node thereto; and

processing for causing the plurality of the calculation means to perform path calculations between the start node and nodes belonging to a group of nodes to which distances from the start node are relatively short, and thereafter to perform path calculations between the start node and nodes belonging to a group of nodes to which distances from the start node are relatively long.

### [Mode 22]

The program according to Mode 20 or 21, wherein the program further allows the computer to execute:

processing for causing the plurality of the calculation means to exchange with each other pieces of information which indicates whether or not distances from the start node to nodes included in the region(s) allocated to the plurality of the calculation means have been updated, in the middle of path calculations.

### [Mode 23]

A path calculation device according to the above-described second aspect.

### [Mode 24]

The path calculation device according to Mode 23, wherein

the control means divides nodes included in each of the plurality of regions into groups in accordance with distances from the start node thereto, and causes calculation means to perform path calculations between the start node and nodes belonging to a group of nodes to which distances from the start node are relatively short, and thereafter to perform path calculations between the start node and nodes belonging to a group of nodes to which distances from the start node are relatively long.

### [Mode 25]

The path calculation device according to Mode 24, wherein

the control means divides nodes included in each of the plurality of regions into different groups for each integer multiple of a predetermined parameter in accordance with distances from the start node.

### [Mode 26]

The path calculation device according to any one of Mode 23 to 25, wherein the control means predicts the number of nodes to which distances from the start node are to be updated on the basis of a processing time taken to perform a previous round of update processing.

### [Mode 27]

A path calculation method including the steps of:

controlling, by a control means, a calculation means for performing assigned processing in parallel using a plurality of threads; and

depending on whether or not the number of nodes, to which distances from the start node are to be updated, among nodes included in a graph which is object of path calculation, is greater than or equal to a predetermined number, causing, by the control means, the calculation means either to generate threads that update distances from the start node to all nodes included in the graph, or to generate threads that update distances from the start node to nodes to which distances from the start node have a possibility of being updated.

### [Mode 28]

A program allows a computer to execute:

processing for controlling calculation means for performing assigned processing in parallel using a plurality of threads; and

depending on whether or not the number of nodes, to which distances from the start node are to be updated, among nodes included in a graph which is object of path calculation, is greater than or equal to a predetermined number, processing for causing the calculation means either to generate threads that update distances from the start node to all nodes included in the graph, or to generate threads that update distances from the start node to nodes to which distances from the start node have a possibility of being updated.

It should be noted that all the disclosure of the above-described non patent literature are hereby incorporated herein by reference. The exemplary embodiments may be changed and adjusted in the scope of the entire disclosure (including claims) of the present invention and based on the basic technological concept. In the scope of the claims of the present invention, various disclosed elements (including respective elements of the claims, respective elements of the exemplary embodiments, respective elements of the drawings, and so on) may be combined and selected in a variety of ways. That is, it is apparent that the present invention includes various modifications and changes that may be made by those skilled in the art based on the entire disclosure including the claims and on the technical concept. In particular, with regard to ranges of numerical values set forth herein, arbitrary numerical values or sub-ranges contained within said ranges should be interpreted as being specifically set forth, even if not otherwise set forth.

### REFERENCE SIGNS LIST

1 GPU control CPU
2, 2A, 2B, 5 I/O bus
3, 3A, 3B, 6 GPU board
10 Control means
11, 12, 13 GPU control program
20 Calculation means
31, 31A, 31B, 61 GPU
32, 32A, 32B, 62 GPU memory
41, 42 Graph
100 Path calculation device
311, 313A, 313B, 611 Path calculation program
312, 312A, 312B, 612 Core
321, 322A, 322B, 621 Graph data
A to R Node
G11, G21A, G31 Edge distance array
G12, G22A, G22B, G32 Node distance array
G13, G23A, G33 Node updating distance array
G14, G24A, G24B Bucket array
G15, G25A, G34 Path array
G16, G26A, G26B, G35 Update array

What is claimed is:

1. A path calculation device, comprising:
a calculation unit that is configured to perform assigned processing in parallel using a plurality of threads; and
a control unit that is configured to control the calculation unit,
wherein the control unit:
divides nodes that are included in a graph which is object of path calculation, into groups in accordance with distances from a start node; and
causes the calculation unit to perform path calculations between the start node and nodes belonging to a group of nodes to which distances from the start node are relatively short and thereafter to perform path calculations between the start node and nodes belonging to a group of nodes to which distances from the start node are relatively long.

2. The path calculation device according to claim 1, wherein
the control unit divides nodes included in the graph into different groups for each integer multiple of a predetermined parameter in accordance with distances from the start node.

3. The path calculation device according to claim 1, wherein
depending on whether or not the number of nodes, to which distances from the start node are to be updated among nodes included in the graph, is greater than or equal to a predetermined number, the control unit, causes the calculation unit either to generate threads that update distances from the start node to all nodes included in the graph, or to generate threads that update distances from the start node to nodes to which distances from the start node have a possibility of being updated.

4. The path calculation device according to claim 3, wherein
the control unit predicts the number of nodes to which distances from the start node are to be updated, on the basis of a processing time taken to perform the previous round of update processing.

5. The path calculation device according to claim 1, further comprising:
a plurality of the calculation unit,
wherein the control unit:
divides the graph into a plurality of regions by a number greater than the number of the plurality of the calculation unit;
allocates the plurality of regions to the plurality of the calculation unit at random; and
causes the plurality of the calculation unit to perform path calculations between nodes included in the region(s) allocated thereto and the start node.

6. The path calculation device according to claim 5, wherein
the control unit divides nodes included in each of the plurality of regions into groups in accordance with distances from the start node thereto, and causes the plurality of the calculation unit to perform path calculations between the start node and nodes belonging to a group of nodes to which distances from the start node are relatively short, and thereafter to perform path calculations between the start node and nodes belonging to a group of nodes to which distances from the start node are relatively long.

7. The path calculation device according to claim 6, wherein
the control unit divides nodes included in each of the plurality of regions into different groups for each integer multiple of a predetermined parameter in accordance with distances from the start node.

8. The path calculation device according to claim 5, wherein
the control unit causes the plurality of the calculation unit to exchange with each other pieces of information which indicates whether or not distances from the start node to nodes included in the region(s) allocated to the plurality of the calculation unit have been updated in the middle of path calculations.

9. A path calculation device, comprising:
a calculation unit that is configured to perform assigned processing in parallel using a plurality of threads; and
a control unit that is configured to control the calculation unit,
wherein depending on whether or not the number of nodes, to which distances from a start node are to be updated among nodes included in a graph which is object of path calculation, is greater than or equal to a predetermined number, the control unit causes the calculation unit either to generate threads that update distances from the start node to all nodes included in the graph, or to generate threads that update distances from the start node to nodes to which distances from the start node have a possibility of being updated.

10. The path calculation device according to claim 9, wherein
the control unit predicts the number of nodes to which distances from the start node are to be updated, on the basis of a processing time taken to perform a previous round of update processing.

11. A path calculation method comprising:
by a control means that is configured to control a calculation means that is configured to perform assigned processing in parallel using a plurality of threads, dividing nodes that are included in a graph which is object of path calculation into groups in accordance with distances from a start node; and
causing, by the control means, the calculation means to perform path calculations between the start node and nodes belonging to a group of nodes to which distances from the start node are relatively short and thereafter to perform path calculations between the start node and nodes belonging to a group of nodes to which distances from the start node are relatively long.
